(19) United States
(12) Patent Application Publication
(10) Pub. No.: US 2008/0192314 A1
(43) Pub. Date: Aug. 14, 2008

(54) APPARATUS AND METHOD TO ENCODE INFORMATION INTO A HOLOGRAPHIC DATA STORAGE MEDIUM

(75) Inventors: ALLEN KEITH BATES, TUCSON, AZ (US); NILS HAUSTEIN, SOERGENLOCH (DE); CRAIG ANTHONY KLEIN, TUCSON, AZ (US); DANIEL JAMES WINARSKI, TUCSON, AZ (US)

Correspondence Address: DALE F. REGELMAN;QUARLES & BRADY, LLP, ONE SOUTH CHURCH AVENUE, STE. 1700, TUCSON, AZ, 85701-1621, US

(73) Assignee: INTERNATIONAL BUSINESS MACHINES CORPORATION, Armonk, NY (US)

(21) Appl. No.: 11/672,889

(22) Filed: Feb. 8, 2007

(51) Int. Cl. G03H 1/04

(52) U.S. Cl. 359/35; 359/27

(57) ABSTRACT

A method is disclosed to encode information in a holographic data storage medium. The method supplies a holographic information storage system comprising a laser light source, a spatial light modulator, and a holographic data storage medium. The method energizes the laser light source using first power comprising a first current, disposes a data image on the spatial light modulator, and further energizes the laser light source using second power comprising a second current, wherein the second current is greater than the first current. The method forms a data beam comprising said data image, forms a hologram comprising said data image, and encodes an interference pattern comprising the hologram in the holographic data storage medium.

### FIELD OF THE INVENTION

This invention relates to an apparatus, and method using that apparatus, to encode information in a holographic data storage medium.

### BACKGROUND OF THE INVENTION

In holographic information storage, an entire page of information is stored at once as an optical interference pattern within a thick, photosensitive optical material. This is done by intersecting two coherent laser beams within the storage material. The first, called the data beam, contains the information to be stored; the second, called the reference beam, is designed to be simple to reproduce—for example, a simple collimated beam with a planar wavefront.

The resulting optical interference pattern, of the two coherent laser beams, causes chemical and/or physical changes in the photosensitive medium: a replica of the interference pattern is stored as a change in the absorption, refractive index, or thickness of the photosensitive medium. When the stored interference grating is illuminated with one of the two waves that was used during recording, some of this incident light is diffracted by the stored grating in such a fashion that the other wave is reconstructed. Illuminating the stored grating with the reference wave reconstructs the data beam, and vice versa.

A large number of these interference gratings or patterns can be superimposed in the same thick piece of media and can be accessed independently, as long as they are distinguishable by the direction or the spacing of the gratings. Such separation can be accomplished by changing the angle between the object and reference wave or by changing the laser wavelength. Any particular data page can then be read out independently by illuminating the stored gratings with the reference wave that was used to store that page. Because of the thickness of the hologram, this reference wave is diffracted by the interference patterns in such a fashion that only the desired object beam is significantly reconstructed and imaged on an electronic camera. The theoretical limits for the storage density of this technique are on the order of tens of terabits per cubic centimeter.

### SUMMARY OF THE INVENTION

What is needed is an apparatus, and a method using that apparatus, to enhance the integrity of information encoded in a holographic information storage. Applicants' invention comprises a method to encode information in a holographic data storage medium. The method supplies a holographic information storage system comprising a laser light source, a spatial light modulator, and a holographic data storage medium. The method further energizes the laser light source using first power comprising a first current, disposes a data image on the spatial light modulator, and further energizes the laser light source using second power comprising a second current, wherein the second current is greater than the first current. The method forms a data beam comprising the data image, forms a hologram comprising the data image, and encodes an interference pattern comprising the hologram in the holographic data storage medium.

### BRIEF DESCRIPTION OF THE DRAWINGS

The invention will be better understood from a reading of the following detailed description taken in conjunction with the drawings in which like reference designators are used to designate like elements, and in which:

FIG. 1 is a perspective view of a holographic information recording apparatus;

FIG. 2 is a view showing Applicants' holographic information recording apparatus;

FIG. 3 is a perspective view of Applicants' holographic information recording apparatus;

FIG. 4 is a perspective view of a holographic information reading apparatus; and

FIG. 5 is a perspective view of Applicants' holographic information reading apparatus;

FIG. 6 is a block diagram of Applicants' data storage system which comprises Applicants' holographic information recording apparatus of FIGS. 2 and 3, and Applicants' holographic information reading apparatus of FIG. 5;

FIG. 7 is a flow chart summarizing the steps of Applicants' method to encode information in a holographic data storage medium;

FIG. 8 shows the profile of current with respect to time provided to a laser light source to read information encoded in a holographic data storage medium;

FIG. 9 shows the profile of current with respect to time provided to a laser light source using prior art methods to encode information in a holographic data storage medium; and

FIG. 10 shows the profile of current with respect to time provided to a laser light source using Applicants' method to encode information in a holographic data storage medium

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

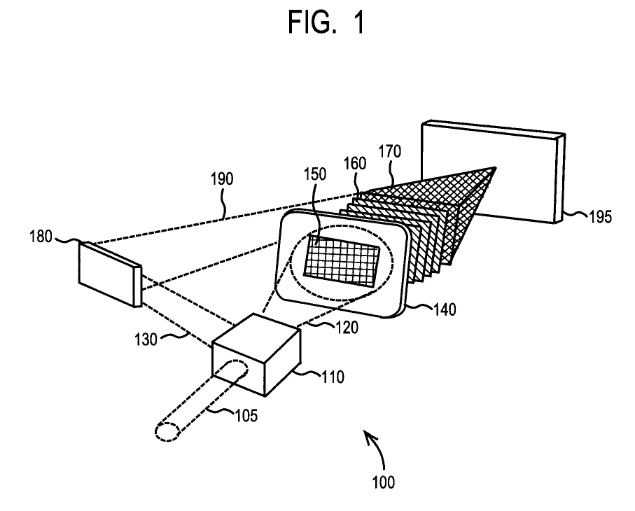

FIG. 1 illustrates holographic information recording apparatus 100. Apparatus 100 comprises a laser light source 105, a laser splitter 110, carrier beam 120, and reference beam 130. In the illustrated embodiment of FIG. 1, apparatus 100 further comprises a transmissive spatial light modulator (“TSLM”) 140, a data beam 160, a mirror 180, and a holographic data storage medium 195.

In certain embodiments, laser light source 105 comprises a “red” laser, such as for example a GaInP laser or —GaN laser, or a second-harmonic generation (“SHG”) laser, emitting laser light having wavelengths of between about 600 to about 680 nm. In other embodiments, laser light source 105 comprises a “blue” laser, such as for example a Krypton ion laser, or a GaN In-doped laser, emitting laser light having wavelengths as low as about 400 to about 480 nm.

Generally, the TSLM 140 is a Liquid Crystal Display (“LCD”) type device. Information is represented by either a light or a dark pixel on the TSLM 140 display. The TSLM 140 is typically translucent. Laser light originating from the laser source 105 is split by the beam splitter 110 into two beams, a carrier beam 120 and a reference beam 130. The carrier beam 120 picks up the image 150 displayed by the TSLM 140 as the light passes through the TSLM 140.

Reference beam 130 is reflected by the mirror 180 to produce reflected reference beam 190. Reflected reference beam 190 interferes with the data beam 160 to form hologram 170. Hologram 170 is encoded as an interference pattern in holographic storage medium 195.

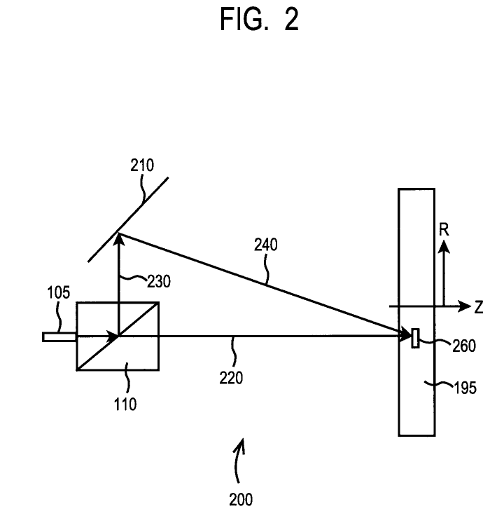

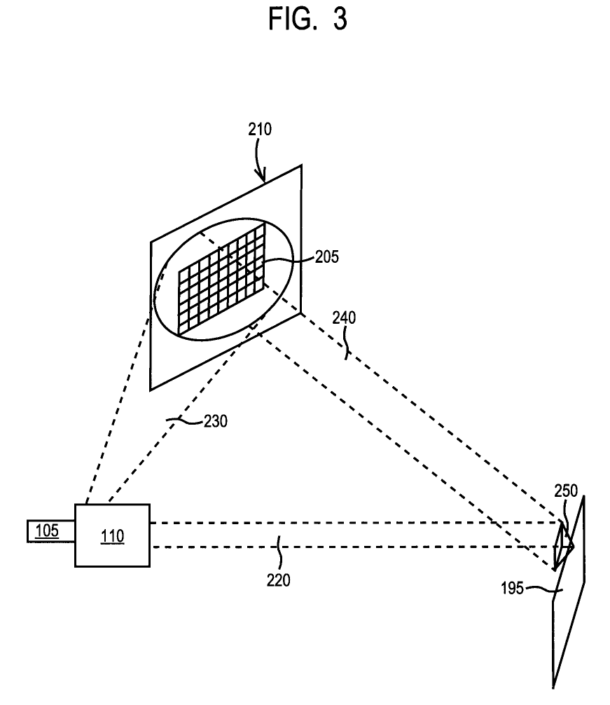

Referring now to FIGS. 2 and 3, holographic information recording apparatus 200 comprises laser light source 105, splitter 110, reflective spatial light modulator 210, and holographic storage medium 195. The light generated by source 105 is split by splitter 110 into reference beam 220, and carrier beam 230. Carrier beam 230 picks up image 205 as the light is reflected off reflective spatial light modulator (“RSLM”) 210 to form reflected data beam 240 comprising image 205. Unreflected reference beam 220 interferes with reflected data beam 240 to form hologram 250. Hologram 250 is formed within storage medium 195 thereby causing the photo-active storage medium to create an interference pattern 260 comprising the encoded hologram 250.

In certain embodiments, reflective spatial light modulator 210 comprises an assembly comprising a plurality of micro mirrors. In other embodiments, reflective spatial light modulator 210 comprises a liquid crystal on silicon (“LCOS”) display device. In contrast to nematic twisted liquid crystals used in LCDs, in which the crystals and electrodes are sandwiched between polarized glass plates, LCOS devices have the liquid crystals coated over the surface of a silicon chip. The electronic circuits that drive the formation of the image are etched into the chip, which is coated with a reflective (aluminized) surface. The polarizers are located in the light path both before and after the light bounces off the chip. LCOS devices are easier to manufacture than conventional LCD displays. LCOS devices have higher resolution because several million pixels can be etched onto one chip. LCOS devices can be much smaller than conventional LCD displays.

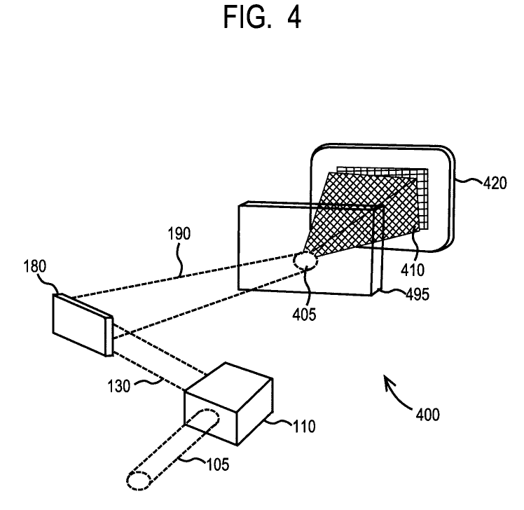

FIG. 4 illustrates holographic information reading apparatus 400. Apparatus 400 comprises laser light source 105, beam splitter 110, encoded holographic storage medium 495, and optical sensor 420. Optical sensor 420 is disposed a distance away from the holographic storage medium 495 sufficient to accurately capture the image 410 projected. To read the hologram, reference beam 130 is reflected off of mirror 180, to become reflected reference beam 190, which is then incident on the holographic storage medium 495. As the reference beam 190 interferes with the encoded hologram 405 stored on the storage medium 195, an image 410 resembling the original image 150 (FIG. 1) displayed by the TSLM 140 (FIG. 1) is projected against the optical sensor 420. The optical sensor 420 then captures the information comprising image 410.

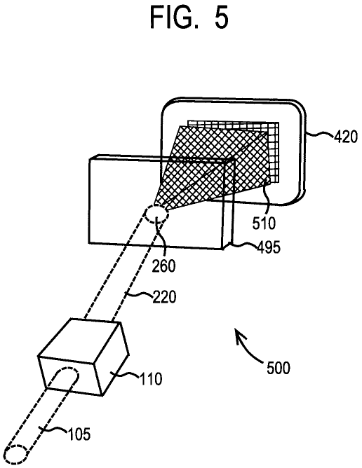

FIG. 5 shows holographic information reading apparatus 500. Apparatus 500 comprises laser light source 105, optional beam splitter 110, and optical sensor 420. Light source 105 and splitter 10 provide reference beam 220.

The unreflected reference beam 220 is onto encoded holographic storage medium 495 such that reference beam 220 is diffracted by the interference pattern 260 (FIG. 2) to form image 510 resembling the original image 205 (FIG. 3) displayed on Applicants' reflective spatial light modulator 210. Image 510 is projected against the optical sensor 420. The optical sensor 420 then captures the information comprising image 510.

In the illustrated embodiment of FIG. 5, holographic information reading apparatus 500 comprises beam splitter 110. In other embodiments, holographic information reading apparatus 500 does not comprise a beam splitter. In these embodiments, laser light source 105 provides reference beam 220, which is directed without reflection onto encoded holographic storage medium 495 such that reference beam 220 is diffracted by the interference pattern 260 (FIG. 2) to form image 510 resembling the original image 205 (FIG. 3) displayed on Applicants' reflective spatial light modulator 210. Image 510 is projected against the optical sensor 420. The optical sensor 420 then captures the information comprising image 510.

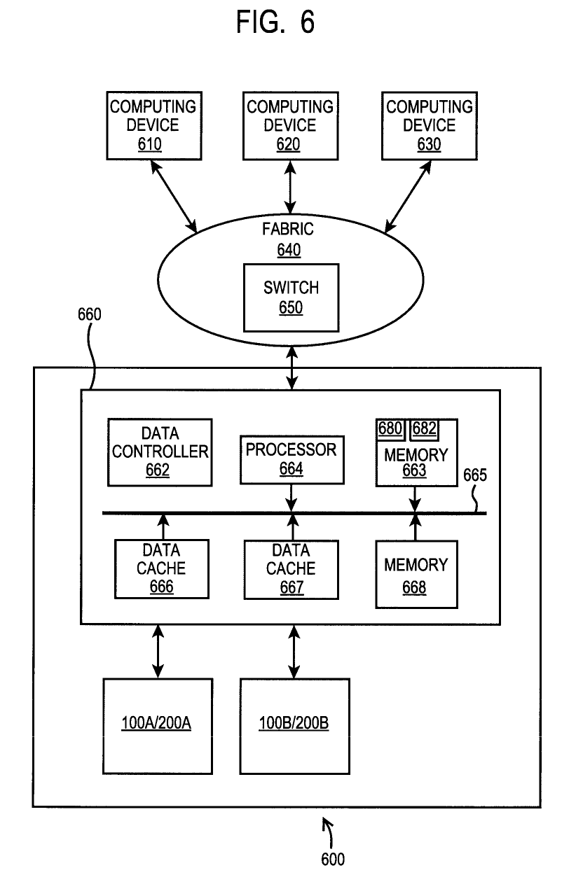

FIG. 6 illustrates one embodiment of Applicants' holographic data storage and retrieval system 600. In the illustrated embodiment of FIG. 6, holographic data storage and retrieval system 600 communicates with computing devices 610, 620, and 630. In the illustrated embodiment of FIG. 6, computing devices 610, 620, and 630 communicate with storage controller 660 through a data communication fabric 640. In certain embodiments, fabric 640 comprises one or more data switches 650. Further in the illustrated embodiment of FIG. 6, storage controller 660 communicates with one or more holographic data storage systems.

In the illustrated embodiment of FIG. 6, holographic data storage and retrieval system 600 comprises a first holographic data system 100 (FIG. 1), shown as system 100A, and a second holographic data storage system 100, shown as system 100B. In the illustrated embodiment of FIG. 6, holographic data storage and retrieval system 600 comprises a first holographic data storage system 200 (FIG. 2), shown as system 200A, and a second holographic data storage system 200, shown as system 200B.

In certain embodiments, computing devices 610, 620, and 630, are selected from the group consisting of an application server, a web server, a work station, a host computer, or other like device from which information is likely to originate. In certain embodiments, one or more of computing devices 610, 620, and/or 630 are interconnected with fabric 640 using Small Computer Systems Interface (“SCSI”) protocol running over a Fibre Channel (“FC”) physical layer. In other embodiments, the connections between computing devices 610, 620, and 630, comprise other protocols, such as Infiniband, Ethernet, or Internet SCSI (“iSCSI”). In certain embodiments, switches 650 are configured to route traffic from the computing devices 610, 620, and/or 630, directly to the storage controller 660.

In the illustrated embodiment of FIG. 6, storage controller 660 comprises a data controller 662, memory 663, memory 668, processor 664, and data caches 666 and 667, wherein these components communicate through a data bus 665. Microcode/instructions 680 are encoded in memory 663. Processor 664 utilizes microcode/instructions 680 to operate storage controller 660. Microcode/instructions 682 are encoded in memory 663. Processor 664 utilizes microcode/instructions 682 to operate one or more of holographic data storage systems 100A, 100B, 200A, and/or 200B.

In certain embodiments, memory 663 comprises a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like. In certain embodiments, memory 668 comprises a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

In certain embodiments, the storage controller 660 is configured to read data signals from and write data signals to a serial data bus on one or more of the computing devices 610, 620, and/or 630. Alternatively, in other embodiments the storage controller 660 is configured to read data signals from and write data signals to one or more of the computing devices 610, 620, and/or 630, through the data bus 665 and the fabric 640.

In certain embodiments, storage controller 660 converts a serial data stream into a convolution encoded data images. In certain embodiments, those data images are transferred to a TSLM 140 (FIG. 1) disposed in one or more of holographic encoding/decoding systems 100A and/or 100B. In certain embodiments, those data images are transferred to an RSLM 210 (FIGS. 2, 3) disposed in one or more of holographic encoding/decoding systems 200A and/or 200B

In certain embodiments, holographic data storage systems 100A and 100B, and/or 200A and 200B, are located in different geographical places. In certain embodiments, storage controller 660 distributes information between two or more holographic encoding/decoding systems in order to protect the information.

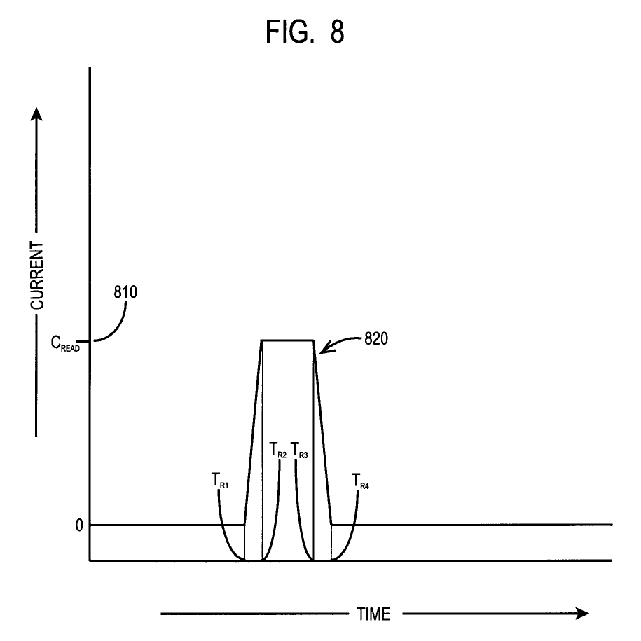

Referring now to FIG. 8, when decoding information from an encoded holographic data storage medium, such as encoded holographic data storage medium 495 (FIGS. 4, 5), the laser light source, such as laser light source 105, is energized to generate a read pulse, wherein the power supplied to the laser light source comprises current profile 820.

At time T_{R1}, the laser light source is energized, wherein the energizing current begins to rise from 0 current. At time T_{R2}, the energizing current reaches the desired Read Current level 810 shown as C_{READ}, and the Read Current is maintained from time T_{R2} to time T_{R3}. Beginning at time T_{R3}, the energizing current drops from C_{READ} to 0 current, which is reached at time T_{R4}.

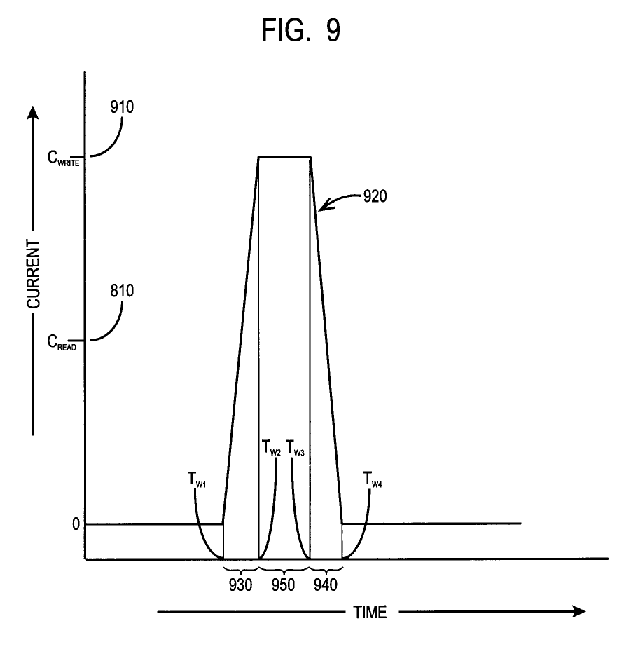

Referring now to FIG. 9, when encoding information into a holographic data storage medium using prior methods the laser light source, such as laser light source 105, is energized to generate a write pulse, wherein the power supplied to the laser light comprises current profile 920. At time T_{W1}, the laser light source is energized, wherein the energizing current begins to rise from 0 current. At time T_{W2}, the energizing current reaches the desired Write Current level 910 shown as C_{WRITE}, and the Write Current is maintained from time T_{W2} to time T_{W3}, for encoding time interval 950 Beginning at time T_{W3}, the energizing current drops from C_{WRITE} to 0 current, which is reached at time T_{W4}

Applicants have found that using the prior art methods, the aggregate current ramping time, comprising a ramp-up time interval 930 in combination with a ramp-down time interval 940, can be long. Applicants' have further found that where the aggregate current ramping time is long, the encoded interference pattern may comprise an indefinite, i.e. “fuzzy”, holographic image. Such “fuzzy” holographic images adversely affect the integrity and detectability of the holographically encoded data.

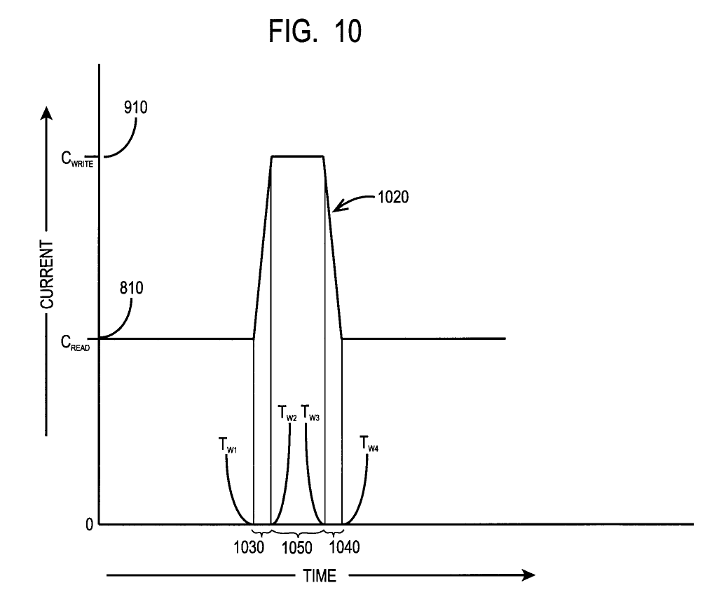

Referring now to FIG. 10, when encoding information into a holographic data storage medium using Applicants' method the laser light source, such as laser light source 105, is energized to generate an improved write pulse, wherein the power supplied to the laser light comprises current profile 1020. Using Applicants' method the laser light source remains energized at the Read Current level C_{READ} 810 prior to writing. At time T_{W1}, the laser light source is further energized, wherein the energizing current begins to rise from C_{READ} 810. At time T_{W2}, the energizing current reaches the desired Write Current level 910 shown as C_{WRITE}, and the Write Current is maintained from time T_{W2} to time T_{W3}, for encoding time interval 1050 (T_{W3}-T_{W2}). Beginning at time T_{W3}, the energizing current drops from C_{WRITE} 910 to C_{READ} 810 at time T_{W4}.

Using Applicants' method, both the ramp-up time interval 1030 (T_{W2}-T_{W1}) and the ramp-down time interval 1040 (T_{W4}-T_{W3}) are shorter than respective ramp-up time interval 930 and ramp-down interval 940 shown in FIG. 9. Applicants' have further found that where the aggregate current ramping time is shorter, the encoded interference pattern comprises a more definite, i.e. “sharp”, holographic image. Such a “sharp” holographic image enhances the integrity and detectability of the holographically encoded data.

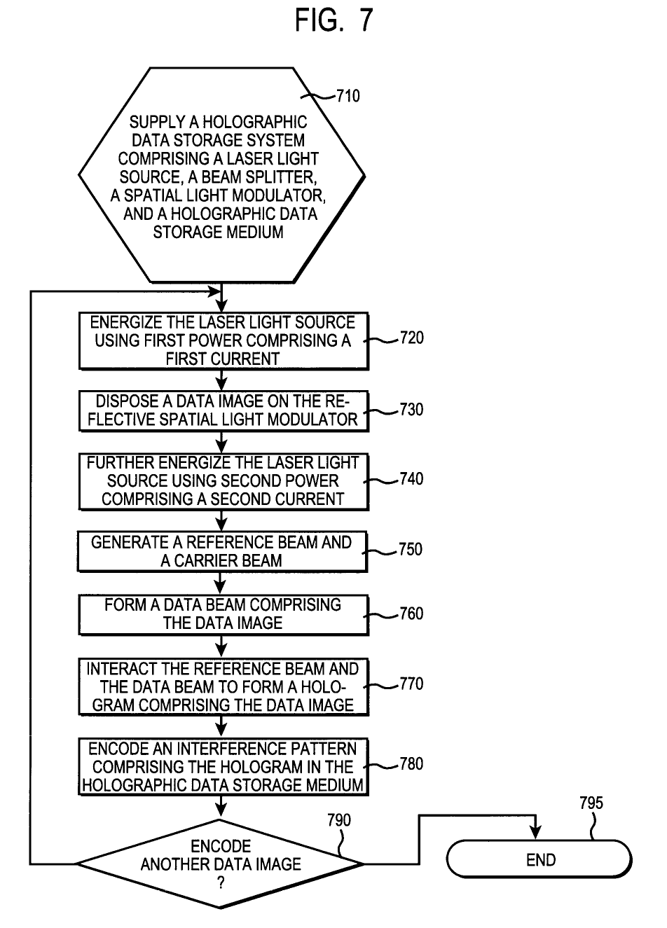

FIG. 7 summarizes the steps of Applicants' method to encode information in a holographic data storage medium. Referring now to FIG. 7, in step 710 Applicants' method supplies a holographic information storage system comprising a laser light source, a beam splitter, a spatial light modulator, and a holographic data storage medium.

In certain embodiments, the spatial light modulator comprises a transmissive spatial light modulator, such as transmissive spatial light modulator 140 (FIG. 1). In other embodiments, the spatial light modulator comprises a reflective spatial light modulator, such as reflective spatial light modulator 210 (FIGS. 2, 3).

In step 720, Applicants' method energizes the laser light source using a first input power comprising a first current level, whereby the laser light source emits a first laser beam comprising a first intensity. In certain embodiments, the first current level comprises a Read Current C_{READ} 810 as described herein. In certain embodiments, the first current level comprises an Erase Current C_{ERASE} for rewritable holographic media, where C_{READ}<C_{ERASE}<C_{WRITE}. In certain embodiments, step 720 is performed by a processor, such as processor 664 (FIG. 6) disposed in a storage controller, such as storage controller 660, in communication with the holographic data storage system of step 710.

In step 730, Applicants' method disposes a data image on the spatial light modulator. In certain embodiments, step 730 is performed by a processor, such as processor 664 (FIG. 6) disposed in a storage controller, such as storage controller 660, in communication with the holographic data storage system of step 710.

In step 740, Applicants' method further energizes the laser light source using a second input power comprising a second current level, i.e. a Write Current C_{write} 910 whereby the laser light source emits a second laser beam comprising a second intensity. In certain embodiments, the second input power of step 740 is about two to four times the first input power of step 720. In certain embodiments, step 740 is performed by a processor, such as processor 664 (FIG. 6) disposed in a storage controller, such as storage controller 660, in communication with the holographic data storage system of step 710.

In step 750, Applicants' method generates a reference beam and a carrier beam. In step 760, Applicants' method forms a data beam comprising the data image of step 730. In step 770, Applicants' method interferes the reference beam and the data beam to form a holograph comprising the data image. In step 780, Applicants' method encodes an interference pattern in the holographic data storage medium, wherein that interference pattern comprises the hologram of step 770.

In step 790, Applicants' method determines if additional information is to be encoded in the holographic data storage medium. In certain embodiments, step 790 is performed by a processor, such as processor 664 (FIG. 6) disposed in a storage controller, such as storage controller 660, in communication with the holographic data storage system of step 710.

If Applicants' method elects in step 790 to encode additional information into the holographic data storage medium, then the method transitions from step 790 to step 720 and continues as described herein. Alternatively, if Applicants' method determines in step 790 not to encode additional information into the holographic data storage medium, then the method transitions from step 790 to step 795 and ends.

In certain embodiments, individual steps recited in FIG. 7 may be combined, eliminated, or reordered.

In certain embodiments, Applicants' invention includes instructions, such as microcode/instructions 682, residing memory 663 (FIG. 6), where those instructions are executed by a processor, such as processor 664 (FIG. 6), to perform one or more of steps 720, 730, 740, and/or 790, recited in FIG. 7.

In other embodiments, Applicants' invention includes instructions residing in any other computer program product, where those instructions are executed by a computer external to, or internal to, system 600, to perform one or more of steps 720, 730, 740, and/or 790, recited in FIG. 7. In either case, the instructions may be encoded in an information storage medium comprising, for example, a magnetic information storage medium, an optical information storage medium, an electronic information storage medium, and the like. By “magnetic storage medium,” Applicants mean, for example, a device such as a hard disk drive, floppy disk drive, or magnetic tape. By “optical information storage medium,” Applicants mean, for example, a Digital Versatile Disk (“DVD”), High-Definition DVD (“HD-DVD”), Blu-Ray Disk (“BD”), Magneto-Optical (“MO”) disk, Phase-Change “(PC”) disk, etc. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to encode information in a holographic data storage medium, comprising the steps of:
supplying a holographic information storage system comprising a laser light source, a spatial light modulator, and a holographic data storage medium;
energizing said laser light source using first power comprising a first current;
disposing a data image on the spatial light modulator;
further energizing said laser light source using second power comprising a second current, wherein said second current is greater than said first current;
forming a data beam comprising said data image;
forming a hologram comprising said data image; and
encoding an interference pattern comprising said hologram in said holographic data storage medium.

2. The method of claim 1, wherein said further energizing step further comprises the steps of:
increasing the current supplied to said laser light source from said first current to said second current during a ramp up time interval;
maintaining the current supplied to said laser light source at said second current during an encoding time interval;
decreasing the current supplied to said laser light source from said second current to said first current during a ramp down time interval;
wherein said ramp up time interval and said ramp down time interval are each less than said encoding time interval.

3. The method of claim 1, wherein said first current is selected from the group consisting of a read current and an erase current.

4. The method of claim 1, wherein said second power is about 2 times said first power.

5. The method of claim 1, wherein said spatial light modulator comprises a reflective spatial light modulator.

6. The method of claim 1, wherein said spatial light modulator comprises a transmissive spatial light modulator.

7. The method of claim 1, further comprising the steps of:
electing whether to encode additional information into said holographic data storage medium; and
operative if additional information will be encoded into said holographic data storage medium, repeating said disposing step, said further energizing step, said forming steps, and said encoding step.

8. An storage controller comprising a processor and computer readable program code disposed in a computer readable medium, wherein said storage controller is in communication with a holographic data storage system comprising a laser light source, a spatial light modulator, and a holographic data storage medium, said computer readable program code being useable with said processor to encode information in said holographic data storage medium, the computer readable program code comprising a series of computer readable program steps to effect:
energizing said laser light source using first power comprising a first current;
disposing a data image on the spatial light modulator;
further energizing said laser light source using second power comprising a second current to form a data beam comprising said data image.

9. The storage controller of claim 8, wherein said computer readable program code to further energize the laser light source further comprises a series of computer readable program steps to effect:
increasing the current supplied to said laser light source from said first current to said second current during a ramp up time interval;
maintaining the current supplied to said laser light source at said second current during an encoding time interval;
decreasing the current supplied to said laser light source from said second current to said first current during a ramp down time interval;
wherein said ramp up time interval and said ramp down time interval are each less than said encoding time interval.

10. The storage controller of claim 8, wherein said computer readable program code to energize said laser light source using first power further comprises a series of computer readable program steps to effect selecting said first current from the group consisting of a read current and an erase current.

11. The storage controller of claim 8, wherein said second power is two to four times said first power.

12. The storage controller of claim 8, wherein said spatial light modulator comprises a reflective spatial light modulator.

13. The storage controller of claim 8, wherein said spatial light modulator comprises a transmissive spatial light modulator.

14. The storage controller of claim 8, said computer readable program code comprising a series of computer readable program steps to effect electing whether to encode additional information into said holographic data storage medium.

15. A computer program product encoded in a computer readable medium disposed in a holographic data storage system comprising a processor, a laser light source, a spatial light modulator, and a holographic data storage medium, said computer program product being useable with said processor to encode information in said holographic data storage medium, comprising:
computer readable program code which causes said programmable computer processor to energize said laser light source using first power comprising a first current;
computer readable program code which causes said programmable computer processor to dispose a data image on the spatial light modulator;
computer readable program code which causes said programmable computer processor to further energize said laser light source using second power comprising a second current to form a data beam comprising said data image.

16. The computer program product of claim 15, wherein said computer readable program code to further energize the laser light source further comprises:
computer readable program code which causes said programmable computer processor to increase the current supplied to said laser light source from said first current to said second current during a ramp up time interval;
computer readable program code which causes said programmable computer processor to maintain the current supplied to said laser light source at said second current during an encoding time interval;
wherein said first current is selected from the group consisting of a read current and an erase current decrease the current supplied to said laser light source from said second current to said first current during a ramp down time interval;
wherein said ramp up time interval and said ramp down time interval are each less than said encoding time interval.

17. The computer program product of claim 15, further comprising computer readable program code which causes said programmable computer processor to select said first current from the group consisting of a read current and an erase current.

18. The computer program product of claim 15, wherein said second power is two to four times said first power.

19. The computer program product of claim 15, wherein said spatial light modulator comprises a reflective spatial light modulator.

20. The computer program product of claim 15, wherein said spatial light modulator comprises a transmissive spatial light modulator.
